(19) United States
(12) Patent Application Publication
(10) Pub. No.: US 2026/0316702 A1
(43) Pub. Date: Oct. 15, 2026

(54) POWER MODULE WITH CONFIGURABLE OPERATING MODES

(71) Applicant: GM GLOBAL TECHNOLOGY OPERATIONS LLC, DETROIT, MI (US)

(72) Inventors: Lei Hao, Shelby Township, MI (US); Minh-Khai Nguyen, Troy, MI (US); Yilun Luo, Ann Arbor, MI (US); Dongxu Li, Troy, MI (US)

(21) Appl. No.: 19/174,292

(22) Filed: Apr. 9, 2025

(51) Int. Cl. B60R 16/023; H02J 7/00; H02J 7/06

(52) U.S. Cl. CPC B60R 16/0238; H02J 7/06; H02J 7/865; H02J 2207/20

(57) ABSTRACT

A system for controlling charging and discharging includes a power module configured to be selectively connected to a charging inlet, a power outlet and a battery assembly, the power module including at least one of an AC-AC conversion device and an AC-DC conversion device. The power module also includes a conversion circuit including a conductor connected to a first neutral point of the power module, and a set of switches. The power module further includes a controller configured to control the set of switches to select one of a plurality of operating modes, the plurality of operating modes including a charging mode in which power from a power source charges the battery assembly via the charging inlet, a power outlet discharging mode in which power is provided to a load via the power outlet, and a charging inlet discharging mode in which power is provided via the charging inlet.

### INTRODUCTION

The subject disclosure relates to electric vehicles. More specifically, the disclosure relates to electric vehicle charging and discharging.

Vehicles, including gasoline and diesel power vehicles, as well as electric and hybrid electric vehicles, feature battery storage for purposes such as powering electric motors, electronics and other vehicle subsystems. Such vehicles typically include modules for controlling aspects of charging battery systems. In addition, vehicles may have discharging capabilities for supplying power to external loads (vehicle-to-load or V2L charging), such as power tools, power grids and residential electrical systems, and/or other vehicles (vehicle-to-vehicle or V2V charging).

### SUMMARY

In one exemplary embodiment, a system for controlling charging and discharging includes a power module configured to be selectively connected to a charging inlet, a power outlet and a battery assembly, the power module including at least one of an alternating current (AC)-AC conversion device and an AC-direct current (DC) conversion device. The power module also includes a conversion circuit including a conductor connected to a first neutral point of the power module, and a set of switches. The power module further includes a controller configured to control the set of switches to select one of a plurality of operating modes, the plurality of operating modes including a charging mode in which power from a power source charges the battery assembly via the charging inlet, a power outlet discharging mode in which power is provided to a load via the power outlet, and a charging inlet discharging mode in which power is provided via the charging inlet.

In addition to the one or more features described herein, the conversion circuit is connected to a second neutral point of the power module.

In addition to the one or more features described herein, the set of switches includes a switch configured to be closed to electrically connect a neutral terminal of the power outlet to the first neutral point, the neutral terminal being the second neutral point.

In addition to the one or more features described herein, the AC-AC conversion device is a single stage converter having a stage leg and a pair of capacitors in parallel with the stage leg, and the first neutral point is a midpoint between the pair of capacitors.

In addition to the one or more features described herein, the set of switches includes a first switch and a second switch, and the first switch is configured to be closed and the second switch is configured to be open to discharge power to the load through the charging inlet at a first voltage level.

In addition to the one or more features described herein, the first switch is configured to be open and the second switch is configured to be closed to discharge power to the load through the charging inlet at a second voltage level, the second voltage level being different than the first voltage level.

In addition to the one or more features described herein, the power module includes a transformer, and the first neutral point is a midpoint of a primary winding of the transformer.

In addition to the one or more features described herein, the transformer includes an integrated magnetic core configured to couple the primary winding to a plurality of secondary windings, at least one of the secondary windings connected to a high voltage battery system, and at least another of the secondary windings connected to a low voltage device.

In another exemplary embodiment, a method of controlling charging and discharging of a battery assembly of a vehicle includes connecting a power module to a load or a power source by at least one of a charging inlet and a power outlet, the power module including at least one of an alternating current (AC)-AC conversion device and an AC-direct current (DC) conversion device, the power module connected to a conversion circuit, the conversion circuit including a conductor connected to a first neutral point of the power module, and a set of switches. The method also includes controlling the set of switches to select one of a plurality of operating modes, the plurality of operating modes including a charging mode in which power from a power source charges the battery assembly via the charging inlet, a power outlet discharging mode in which power is provided to the load via the power outlet, and a charging inlet discharging mode in which power is provided via the charging inlet. The method further includes controlling the power module based on the selected operating mode.

In addition to the one or more features described herein, the conversion circuit is connected to a second neutral point of the power module.

In addition to the one or more features described herein, the set of switches includes a switch configured to be closed to electrically connect a neutral terminal of the power outlet to the first neutral point, the neutral terminal being the second neutral point.

In addition to the one or more features described herein, the AC-AC conversion device is a single stage converter having a stage leg and a pair of capacitors in parallel with the stage leg, and the first neutral point is a midpoint between the pair of capacitors.

In addition to the one or more features described herein, the power module is selectively connected to a power generation system including a power generator and an inverter, and the power outlet discharging mode includes a first discharging mode in which power is provided to the load by the power generation system, and a second discharging mode in which power is provided to the load by the battery assembly.

In addition to the one or more features described herein, the set of switches includes a first switch and a second switch, the set of switches are controlled so that the first switch is closed and the second switch is open to discharge power to the load through the charging inlet at a first voltage level, and the set of switches are controlled so that the first switch is open and the second switch is closed to discharge power to the load through the charging inlet at a second voltage level, the second voltage level being different than the first voltage level.

In addition to the one or more features described herein, the power module includes a transformer, and the first neutral point is a midpoint of a primary winding of the transformer.

In addition to the one or more features described herein, the AC-AC conversion device includes a first series of switches configured to be controlled for AC frequency conversion, and a second series of switches connected to the conversion circuit, the second series of switches configured to be controlled to control a power level supplied through the transformer.

In yet another exemplary embodiment, a vehicle system includes a battery assembly, a charging inlet, a power outlet, and a power module configured to be selectively connected to the charging inlet, a power outlet and a battery assembly, the power module including at least one of an alternating current (AC)-AC conversion device and an AC-direct current (DC) conversion device. The vehicle system also includes a conversion circuit including a conductor connected to a first neutral point of the power module, and a set of switches. The vehicle system further includes a controller configured to control the set of switches to select one of a plurality of operating modes, the plurality of operating modes including a charging mode in which power from a power source charges the battery assembly via the charging inlet, a power outlet discharging mode in which power is provided to a load via the power outlet, and a charging inlet discharging mode in which power is provided via the charging inlet.

In addition to the one or more features described herein, the conversion circuit is connected to a second neutral point of the power module.

In addition to the one or more features described herein, the set of switches includes a first switch configured to be closed to electrically connect the first neutral point to at least one of the charging inlet and the power outlet.

In addition to the one or more features described herein, the set of switches includes a second switch configured to be closed to electrically connect a neutral terminal of the power outlet to the first neutral point, the neutral terminal being the second neutral point.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a schematic diagram of an electric or hybrid vehicle, in accordance with an exemplary embodiment;

FIG. 2 is a circuit diagram illustrating a power module configured to control aspects of charging and discharging, the power module including a conversion circuit connected to a neutral point of a converter in the power module, in accordance with an exemplary embodiment;

FIG. 3 is a circuit diagram illustrating a power module configured to control aspects of charging and discharging, the power module including a conversion circuit connected to a neutral point of a converter in the power module, in accordance with an exemplary embodiment;

FIG. 4 is a circuit diagram illustrating a power module configured to control aspects of charging and discharging, the power module including a conversion circuit connected to a middle point of a primary winding of a transformer in the power module, in accordance with an exemplary embodiment;

FIGS. 5A and 5B are circuit diagrams illustrating a power module that includes a transformer having an integrated magnetic core, and a conversion circuit, in accordance with an exemplary embodiment;

FIG. 6 is a circuit diagram illustrating a power module configured to control aspects of supplying power from a generator, the power module including a conversion circuit connected to a neutral point of the power module, in accordance with an exemplary embodiment;

FIG. 7 is a flow diagram depicting aspects of a method of controlling charging or discharging, in accordance with an exemplary embodiment; and

FIG. 8 depicts a computer system for performing aspects of charging and discharging, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with exemplary embodiments, methods, devices and systems are provided for facilitating charging and discharging of battery assemblies and battery systems, such as vehicle battery assemblies. An embodiment of an electrical system of a vehicle includes a power module having an alternating current (AC)-AC converter, an AC-direct current (DC) converter, and a transformer in between the AC-AC converter and the AC-DC converter. The power module also includes a conversion circuit operable by a controller to select various operating modes (e.g., vehicle battery charging, vehicle-to-load charging, etc.). The power module may use an integrated magnetic core of the transformer to generate multiple outputs.

The conversion circuit includes a switching assembly having a set of (i.e., one or more) switches, and a set of conductors configured to electrically connect a neutral point of the power module to a power outlet. The neutral point of the power module, in an embodiment, is selectively connected to a neutral point of the power outlet by controlling one or more of the set of switches.

The conversion circuit allows the power module to operate in any of a plurality of operating modes. In an embodiment, the power module is controllable to generate a split phase voltage including two AC voltages, which may be in phase or out of phase. The power module may be used to control charging of a battery system (e.g., a vehicle battery pack) and to supply power to external loads (e.g., AC loads).

The power module is controllable to output various voltage levels. For example, the power module is controllable to output high voltage DC power (e.g., 120 Volts (V) or 240 V) and/or low voltage DC power, such as 12 V or 48 V to power auxiliary loads.

The embodiments are not limited to use with any specific vehicle or device or system that utilizes battery assemblies, and may be applicable to various contexts. For example, embodiments may be used with automobiles, trucks, aircraft, construction equipment, farm equipment, automated factory equipment and/or any other device or system that may use high voltage battery packs or other battery assemblies.

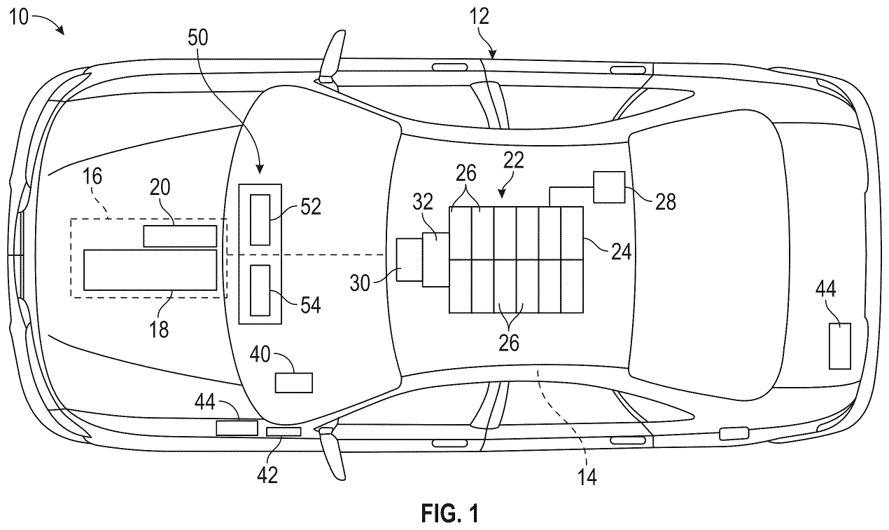

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. In an embodiment, the propulsion system 16 includes an electric motor 20, and may include one or more additional motors positioned at various locations. The vehicle 10 may be a fully electric vehicle having one or more electric motors.

The vehicle 10 includes a battery system 22, which may be electrically connected to the motor 20 and/or other components, such as vehicle electronics. The battery system 22 may be configured as a rechargeable energy storage system (RESS). In an embodiment, the battery system 22 includes a battery assembly such as a high voltage battery pack 24 having a plurality of battery modules 26. The battery system 22 may also include a monitoring unit 28 that includes components such as a processor, memory, an interface, a bus and/or other suitable components.

The battery system 22 is electrically connected to components of the propulsion system 16. The propulsion system 16 includes an inverter module 30 and a DC-DC converter module 32. The inverter module 30 (e.g., a traction power inverter unit or TPIM) converts DC power from the battery system 22 to poly-phase alternating current AC power (e.g., three-phase, six-phase, etc.) to drive the motor 20.

Various control modules (electronic control modules or ECUs) may be included in the vehicle 10. In an embodiment, the vehicle 10 includes a power module 40 that is configured to control aspects of charging the battery pack 24, and discharging the battery pack 24 to supply power to an external system, such as a power grid or other vehicle. The power module 40 is selectively connected to a bi-directional charge port or charging inlet 42 and one or more electrical outlets 44. It is noted that embodiments are not limited to the number or location of outlets and inlets shown, as there may be any number of outlets and inlets at desired locations throughout the vehicle.

The vehicle 10 also includes a computer system 50 that includes one or more processing devices 52 and a user interface 54. The various processing devices and units may communicate with one another via a communication device or system, such as a controller area network (CAN) or transmission control protocol (TCP) bus.

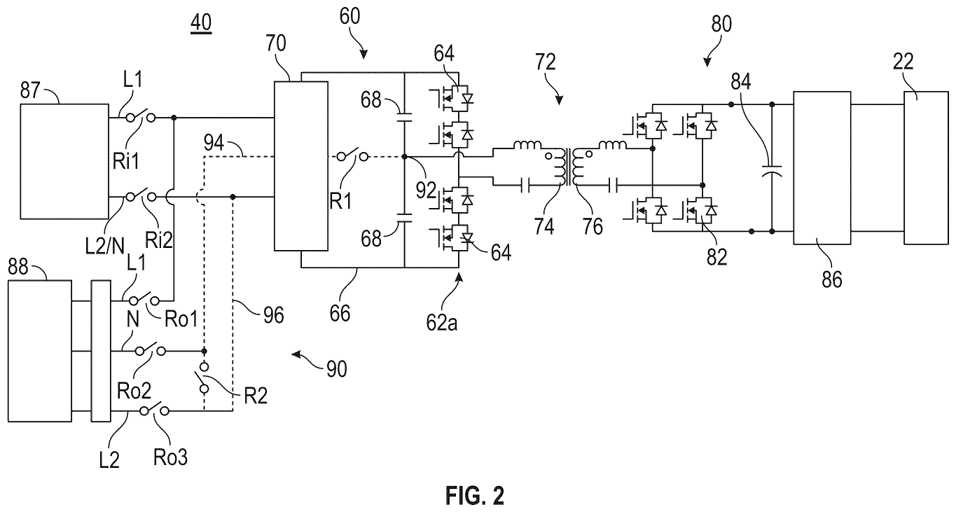

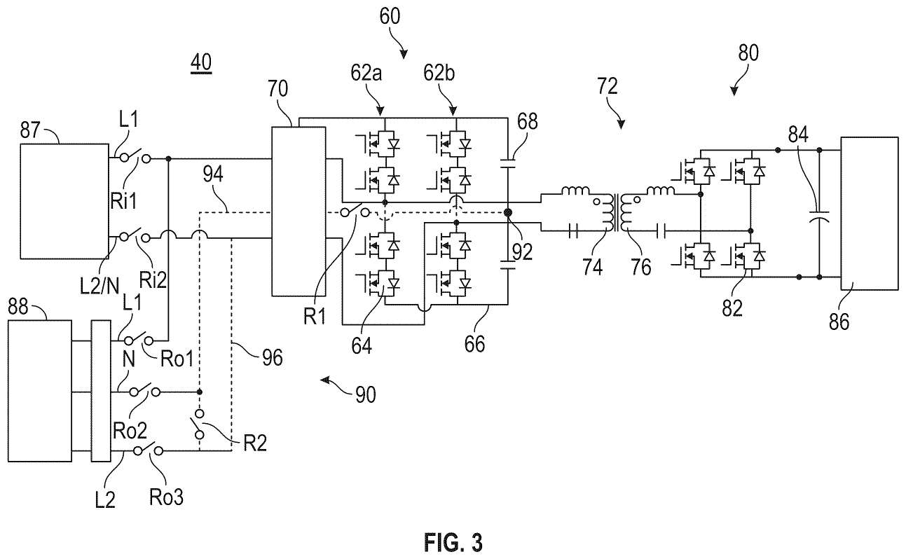

Although FIGS. 2 and 3 show a two-level converter, embodiments are not so limited. The embodiments described herein may be applied to a three-level converter or any multi-level inverter.

FIG. 2 depicts an embodiment of the power module 40, as well as connections between the power module 40 and other components of the vehicle 10. As shown, the power module 40 includes an AC-AC converter 60. The AC-AC converter 60 in this embodiment is a single stage two-level converter (a half bridge matrix converter) having a single phase leg 62a. The phase leg 62a is defined by two pairs of switches 64 connected to an AC bus 66. Two capacitors 68 are connected as a split capacitor to the AC bus 66 in parallel with the pairs of switches 64. An input filter 70 (integrating an inductor) may also be connected to the AC bus 66.

The AC bus 66 is connected to a transformer 72 having a primary winding 74 connected to the AC-AC converter 60, and a secondary winding 76 connected to an AC-DC converter 80. The AC-DC converter 80 includes switches 82 in a full bridge configuration and a capacitor 84. An output filter 86 may be included between the AC-DC converter 80 and the battery system.

A charging inlet 87 (e.g., the charging inlet 42 of FIG. 1) is selectively connected to the AC bus 66 by switches Ri1 and Ri2. The switch Ri1 is connected to a line terminal L1, and the switch Ri2 is connected to a line or neutral terminal L2/N. A power outlet 88 (e.g., the electrical outlet 44 of FIG. 1) is also selectively connected to the AC bus 66, and may have ground fault circuit interrupter (GFCI) functionality. Line switches Ro1 and Ro3 are connected to line terminals L1 and L2 of the power outlet 88, and a neutral switch Ro2 is connected to a neutral terminal N of the power outlet 88.

The power module 40 includes or is connected to a conversion circuit 90, which provides charging and discharging capabilities, including capability for vehicle-to-load (V2L) charging (e.g., at 120 V or 240 V AC power) and/or power splitting (e.g., at 120 V AC power). The conversion circuit 90 provides such capabilities with minimal additional hardware. For example, the conversion circuit 90 is achievable by adding relatively few components (i.e., a set of switches connected to neutral points) and using existing power module (e.g., onboard charging module or OBCM) hardware.

In an embodiment, the conversion circuit 90 has connections to a neutral point of the AC-AC converter 60 and a neutral point of the power outlet 88. For example, as shown in FIG. 2, the conversion circuit 90 is connected to a midpoint 92 of the split capacitor between the capacitors 68.

In this example, the conversion circuit 90 includes a conductor 94 (e.g., cable) that connects the midpoint 92 to the line terminal and a neutral terminal of the power outlet 88. The conversion circuit 90 also includes a conductor 96 that connects a line terminal of the power outlet 88 to the AC bus 66.

The conversion circuit 90, in this example, includes a first switch R1 at the conductor 94 for selective connection of a neutral point of the conversion circuit 90 to the AC-AC converter 60, and a second switch R2 at the conductor 96 for selective connection of the line terminal L2 or the neutral terminal N of the power outlet 88 to the conversion circuit 90.

Control of the switches R1 and R2, in an embodiment, is based on a connection configuration of the charging inlet 87. For example, if the charging inlet 87 uses the line terminal L1 and a neutral connection (i.e., the L2/N terminal is neutral) for discharging, the switches R2 and Ro2 are closed, and the switch Ro3 is open to connect a neutral point of the power outlet 88 to a neutral point of the charging inlet 87. If the charging inlet 87 uses the line terminal L1 and a line connection for the terminal L2/N for discharging, the switch R2 is open and the switch Ro3 is closed to connect the line terminal L2 of the power outlet 88 to the terminal L2/N of the charging inlet 87. The switches may be mechanical relays, power switches (e.g., field effect transducers) or any suitable type of switch device.

The AC-AC converter 60 may be a single phase inverter as shown in FIG. 2, but is not so limited. For example, FIG. 3 depicts an embodiment of the power module, in which the AC-AC converter 60 is a multi-phase converter. In this embodiment, the AC-AC converter 60 includes two phase legs 62a and 62b.

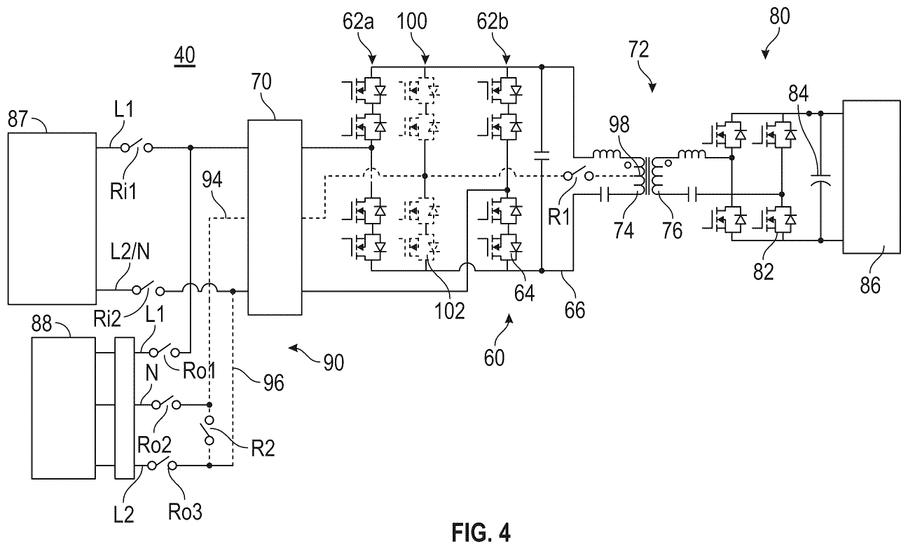

Referring to FIG. 4, in an embodiment, the conversion circuit 90 is connected to a neutral point in the transformer 72. In this embodiment, the transformer 72 is a split transformer.

The conductor 94 and the switch R1 are connected to a midpoint 98 of the primary winding 74. The midpoint 98 is a neutral point in the transformer 72.

An additional phase leg 100 may be included in the AC-AC converter 60. The phase leg 100 includes two pairs of switches 102 that are operable to control split phase operation (when the power module 40 is in a suitable operating mode). The phase leg 100 may also be used to control power and ensure that the correct power is provided from the transformer 72.

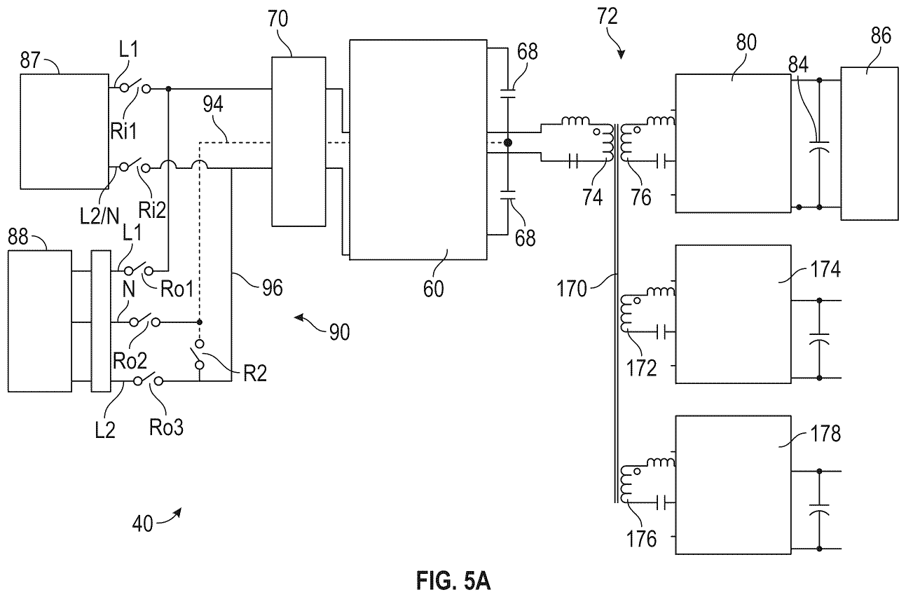

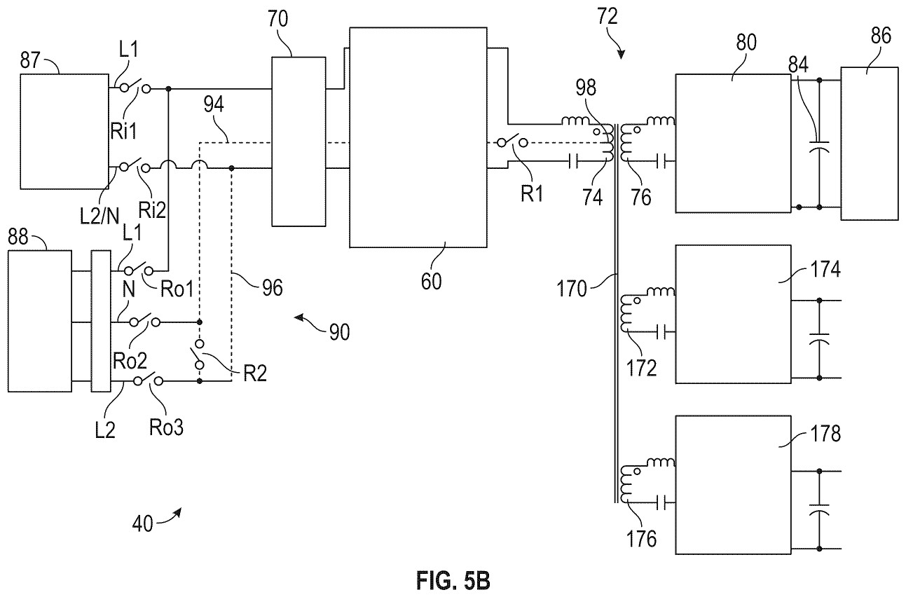

FIGS. 5A and 5B depict embodiments of the power module 40, which utilizes a transformer having an integrated magnetic structure. The AC-AC converter 60 is connected to the transformer 72, which includes an integrated magnetic core 170 having multiple outputs. A first output connects to the AC-DC converter 80, which outputs high voltage DC power to charge the battery system 22. A second output is provided via a secondary winding 172 that connects to a low voltage AC-DC converter 174 that provides low volage DC to power an auxiliary load (e.g., a nominal 12-16 V auxiliary load). A third output is provided via a secondary winding 176 that connects to a low voltage AC-DC converter 178 that provides low volage DC power to an auxiliary load (e.g., a nominal 40-55 V load). The transformer 72 is not limited to three outputs and may have any number (two or more) of outputs. Furthermore, the embodiments are not limited to the specific voltages and loads described herein.

For integrated magnetic core configurations, the neutral point can be generated in a number of ways. For example, as shown in FIG. 5A, the power outlet 88 is connectable to a mid-point of the split capacitor 68 of the AC-AC converter 60 via the switch R2. In another example, shown in FIG. 5B, the power outlet 88 is connectable to a midpoint of the primary winding 74 of the transformer 72 via the switch R1. The neutral point is connected to the charging inlet 87 and the power outlet 88 through the switch R1 in the same way as in the embodiment of FIG. 3 or FIG. 4.

The following table illustrates various operating modes of the embodiments of FIGS. 2-4, 5A and 5B, and the switching position of each switch in each operating mode:

| Operating Mode | Ri1 | Ri2 | Ro1 | Ro2 | Ro3 | R1 | R2 |
|---|---|---|---|---|---|---|---|
| Charging | ON | ON | OFF | OFF | OFF | OFF | OFF |
| Discharging through | ON | ON | OFF | OFF | OFF | OFF | OFF |
| charging inlet | | | | | | | |
| V2L discharging | OFF | OFF | ON | ON | ON | ON | OFF |
| (120 Vand 240 V in | | | | | | | |
| power outlet) | | | | | | | |
| Power splitting | OFF | OFF | ON | ON | N/A | ON | N/A |
| (120 V in power | | | | | | | |
| outlet) | | | | | | | |
| Discharging through | ON | ON | ON | ON | ON | ON | OFF |
| both power outlet | | | | | | | |
| and charging inlet | | | | | | | |
| (240 V) | | | | | | | |
| Discharging through | ON | ON | ON | ON | OFF | OFF | ON |
| both power outlet | | | | | | | |
| and charging inlet | | | | | | | |
| (120 V) | | | | | | | |

In the above, “N/A” indicates that a switch has no function in a given operating mode, and may be excluded from the power module 40 and the conversion circuit 90. For example, the switches Ro3 and R2 may be excluded if only a “power splitting” mode is needed or desired for V2L charging.

In the “charging” mode, the battery system 22 is conventionally charged by a power source via the charging inlet 87. The switches Ri1 and Ri2 are closed (“ON”) and both switches R1 and R2 are open (“OFF”).

In the “discharging through charging inlet” mode, power is supplied from the battery system 22 through the charging inlet 87 to a load.

The conversion circuit 90 provides capability for additional operating modes. In the “V2L discharging” mode, R1 is closed, and all the switches connected to the power outlet 88 are closed. In this mode, power is supplied from the battery system 22, converted to AC power, and transmitted to an AC load via the power outlet 88. In this mode, the power outlet 88 can provide split phase 240 V power through terminals L1 and L2 and 120 V power through terminals L1 and N.

Another additional operating mode is the “power splitting” mode, in which the conversion circuit 90 functions as a power splitter, allowing for 120 V power to be supplied to a load via the power outlet 88.

The conversion circuit 90 can also be configured to cause the power module 40 to supply power through both the charging inlet 87 and the power outlet 88 at various voltage levels. For example, as indicated in the above table (“discharging through both power outlet and charging inlet”), by connecting the charging inlet 87 and at least one line of the power outlet 88, power can be split and supplied through both the charging inlet 87 and the power outlet 88 at a desired voltage (e.g., 120 or 240 V).

Embodiments are not limited to charging and discharging using a battery system. For example, the conversion circuit 90 may be included in the vehicle 10 and use DC power generated by an electric machine (e.g., the electric motor 20 of FIG. 1), which functions as a generator. If the vehicle 10 uses a fuel cell system, the conversion circuit 90 can use DC power generated by the fuel cell system.

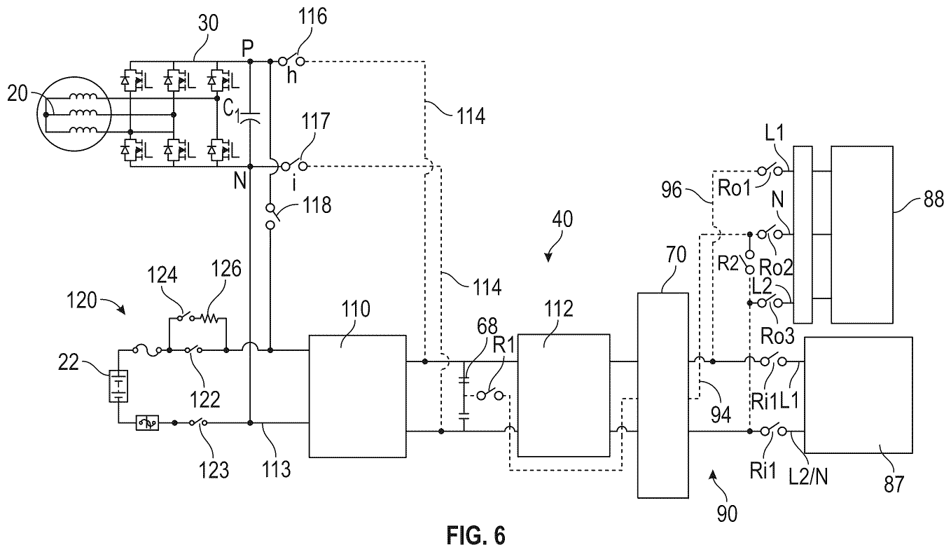

FIG. 6 depicts an embodiment in which the conversion circuit 90 and the power module 40 are used in conjunction with power generation. Although this embodiment is described as being part of the vehicle 10, embodiments are not so limited.

The power module 40 includes an isolated DC-DC converter 110 and an AC-DC converter 112 connected in parallel to a bus 113. The AC-DC converter 112 may have power factor correction (PFC) functionality. For example, the AC-DC converter 112 is used as a 2-phase interleaved boost converter for PFC.

As shown, the conductor 94 bypasses the PFC converter 112, and is connected to the capacitors 68 (forming a split capacitor) connected to a bus 113. Conductors 114 and switches 116, 117 and 118 allow the inverter module 30 to be connected to the bus 113 in parallel with the DC-DC converter 110 and the capacitors 68.

When it is desired to use the motor-inverter system of the vehicle 10 for discharging, the switches 116, 117 and 118 are closed, and the electric motor 20 functions as a generator. The inverter module 30 can be used as a passive or active rectifier to convert AC power generated by the motor 20 to DC power. The DC power flows through the AC-DC converter 112, to provide AC power to a load either through the charging inlet 87 or the power outlet 88. The AC power can be either split phase 240V or 120V, for example. During this operation, the vehicle 10 is in a standstill condition, the battery's main switches 122 and 123 are open, and the switch 118 is open.

When it is desired to use the power module 40 for charging and discharging, the switches 116 and 117 are open, and the power module 40 provides AC power to the power outlet 88 (e.g., at 240V and/or 120V) and/or the charging inlet 87 (240V or 120V). During this operation, the vehicle 10 is in a standstill or moving condition, the battery's main switches 122 and 123 are closed, and the switch 118 is open.

The power module 40 also includes or is connected to a precharge circuit 120, which is operable to precharge the power module 40 and components of the inverter module 30 by providing for a controlled voltage increase. The precharge circuit 120 includes, for example, the main switch 122, and a pre-charge relay 124 and a resistor 126 in parallel with the main switch 122.

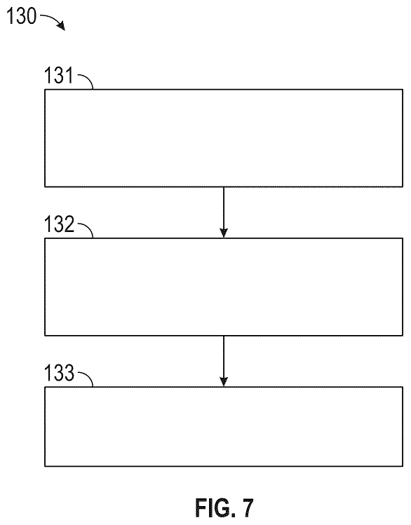

FIG. 7 depicts an embodiment of a method 130 of controlling aspects of an electrical system. The method 130 includes a number of steps or stages represented by blocks 131-133.

The method 130 is described in conjunction with the vehicle 10 of FIG. 1 for illustration purposes. It is understood that the method 130 may be performed using any other embodiment described herein, as well as any suitable vehicle or other electrical system, and any suitable processing device or combination of processing devices.

At block 131, a processor (e.g., the processing device 52 of FIG. 1, a processor connected to the power module 40, etc.) determines that it is desired for the vehicle 10 to transition into a charging or discharging operating mode. For example, the processor may receive a command to put the vehicle 10 into a desired charging mode. Determination of a desired charging mode may be made based on a signal from a charging station, or a signal from a component of the charging inlet 87 and/or the power outlet 88 (or other component) indicating that the vehicle 10 is connected and/or indicating the type of charging.

At block 132, the processor initiates transition to the desired operating mode. Initiation of the transition includes controlling the switch R1 and/or the switch R2, the switches 116, 117 and/or 118, and/or a number of switches connected to the charging inlet 87 and the power outlet 88. The various switches are put into a switching configuration as discussed above, based on the desired operating mode.

At block 133, the power module 40 and other components of the vehicle 10 electrical system are controlled to perform a charging process or a discharging process.

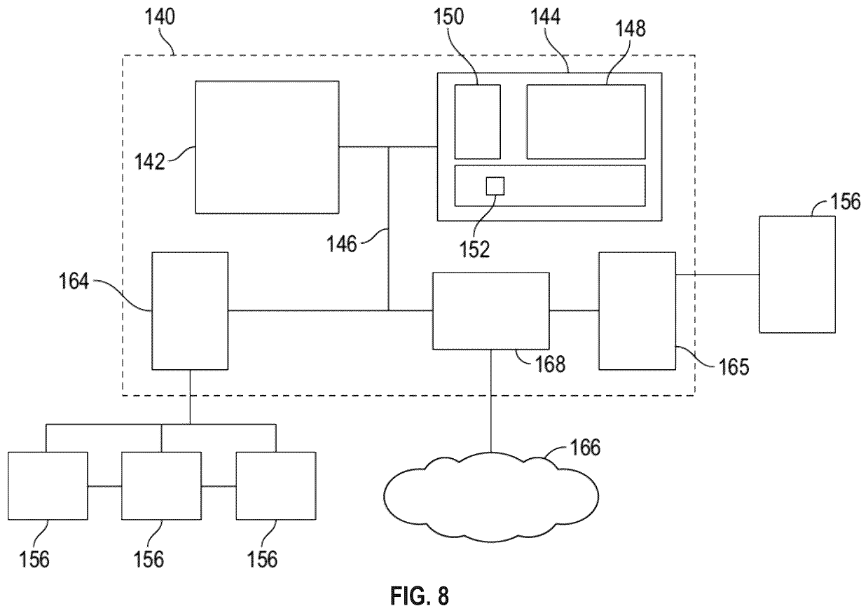

FIG. 8 illustrates aspects of an embodiment of a computer system 140 that can perform various aspects of embodiments described herein. The computer system 140 includes at least one processing device 142, which generally includes one or more processors for performing aspects of methods described herein.

Components of the computer system 140 include the processing device 142 (such as one or more processors or processing units), a memory 144, and a bus 146 that couples various system components including the system memory 144 to the processing device 142. The system memory 144 may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions related to performing charging and discharging operations described herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

What is claimed is:

1. A system for controlling charging and discharging, comprising:
a power module configured to be selectively connected to a charging inlet, a power outlet and a battery assembly, the power module including at least one of an alternating current (AC)-AC conversion device and an AC-direct current (DC) conversion device;
a conversion circuit including a conductor connected to a first neutral point of the power module, and a set of switches; and
a controller configured to control the set of switches to select one of a plurality of operating modes, the plurality of operating modes including a charging mode in which power from a power source charges the battery assembly via the charging inlet, a power outlet discharging mode in which power is provided to a load via the power outlet, and a charging inlet discharging mode in which power is provided via the charging inlet.

2. The system of claim 1, wherein the conversion circuit is connected to a second neutral point of the power module.

3. The system of claim 2, wherein the set of switches includes a switch configured to be closed to electrically connect a neutral terminal of the power outlet to the first neutral point, the neutral terminal being the second neutral point.

4. The system of claim 2, wherein the AC-AC conversion device is a single stage converter having a stage leg and a pair of capacitors in parallel with the stage leg, and the first neutral point is a midpoint between the pair of capacitors.

5. The system of claim 4, wherein the set of switches includes a first switch and a second switch, and the first switch is configured to be closed and the second switch is configured to be open to discharge power to the load through the charging inlet at a first voltage level.

6. The system of claim 5, wherein the first switch is configured to be open and the second switch is configured to be closed to discharge power to the load through the charging inlet at a second voltage level, the second voltage level being different than the first voltage level.

7. The system of claim 2, wherein the power module includes a transformer, and the first neutral point is a midpoint of a primary winding of the transformer.

8. The system of claim 7, wherein the transformer includes an integrated magnetic core configured to couple the primary winding to a plurality of secondary windings, at least one of the secondary windings connected to a high voltage battery system, and at least another of the secondary windings connected to a low voltage device.

9. A method of controlling charging and discharging of a battery assembly of a vehicle, comprising:
connecting a power module to a load or a power source by at least one of a charging inlet and a power outlet, the power module including at least one of an alternating current (AC)-AC conversion device and an AC-direct current (DC) conversion device, the power module connected to a conversion circuit, the conversion circuit including a conductor connected to a first neutral point of the power module, and a set of switches;
controlling the set of switches to select one of a plurality of operating modes, the plurality of operating modes including a charging mode in which power from a power source charges the battery assembly via the charging inlet, a power outlet discharging mode in which power is provided to the load via the power outlet, and a charging inlet discharging mode in which power is provided via the charging inlet; and
controlling the power module based on the selected operating mode.

10. The method of claim 9, wherein the conversion circuit is connected to a second neutral point of the power module.

11. The method of claim 10, wherein the set of switches includes a switch configured to be closed to electrically connect a neutral terminal of the power outlet to the first neutral point, the neutral terminal being the second neutral point.

12. The method of claim 10, wherein the AC-AC conversion device is a single stage converter having a stage leg and a pair of capacitors in parallel with the stage leg, and the first neutral point is a midpoint between the pair of capacitors.

13. The method of claim 12, wherein the power module is selectively connected to a power generation system including a power generator and an inverter, and the power outlet discharging mode includes a first discharging mode in which power is provided to the load by the power generation system, and a second discharging mode in which power is provided to the load by the battery assembly.

14. The method of claim 12, wherein the set of switches includes a first switch and a second switch, the set of switches are controlled so that the first switch is closed and the second switch is open to discharge power to the load through the charging inlet at a first voltage level, and the set of switches are controlled so that the first switch is open and the second switch is closed to discharge power to the load through the charging inlet at a second voltage level, the second voltage level being different than the first voltage level.

15. The method of claim 10, wherein the power module includes a transformer, and the first neutral point is a midpoint of a primary winding of the transformer.

16. The method of claim 15, wherein the AC-AC conversion device includes a first series of switches configured to be controlled for AC frequency conversion, and a second series of switches connected to the conversion circuit, the second series of switches configured to be controlled to control a power level supplied through the transformer.

17. A vehicle system comprising:
a battery assembly;
a charging inlet and a power outlet;
a power module configured to be selectively connected to the charging inlet, a power outlet and a battery assembly, the power module including at least one of an alternating current (AC)-AC conversion device and an AC-direct current (DC) conversion device;
a conversion circuit including a conductor connected to a first neutral point of the power module, and a set of switches; and
a controller configured to control the set of switches to select one of a plurality of operating modes, the plurality of operating modes including a charging mode in which power from a power source charges the battery assembly via the charging inlet, a power outlet discharging mode in which power is provided to a load via the power outlet, and a charging inlet discharging mode in which power is provided via the charging inlet.

18. The vehicle system of claim 17, wherein the conversion circuit is connected to a second neutral point of the power module.

19. The vehicle system of claim 18, wherein the set of switches includes a first switch configured to be closed to electrically connect the first neutral point to at least one of the charging inlet and the power outlet.

20. The vehicle system of claim 19, wherein the set of switches includes a second switch configured to be closed to electrically connect a neutral terminal of the power outlet to the first neutral point, the neutral terminal being the second neutral point.
